(19) United States
(12) Patent Application Publication
(10) Pub. No.: US 2007/0051393 A1
(43) Pub. Date: Mar. 8, 2007

(54) Apparatus for cleaning a wafer

(75) Inventors: Mo-Hyun Cho, Suwon-si (KR); Dong-Chul Heo, Gunpo-si (KR); Duk-Lyol Lee, Hwaseong-si (KR); Tae-Hwan Kim, Hwaseong-si (KR); Tae-Wan Kim, Incheon (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/516,101

(22) Filed: Sep. 6, 2006

(30) Foreign Application Priority Data
Sep. 7, 2005 (KR) 10-2005-0083285

(51) Int. Cl. B08B 3/00; B08B 3/04

(52) U.S. Cl. 134/149; 134/137; 134/104.2; 134/94.1; 134/99.1

(57) ABSTRACT

An apparatus for cleaning a wafer includes a rotary chuck for supporting and rotating a wafer, a cleaning solution supply unit for supplying a cleaning solution onto the wafer, a bowl spaced apart from and surrounding the rotary chuck, and a protrusion portion protruded from the rotary chuck and having a slope face with respect to the rotary chuck. The protrusion portion can prevent an ascending air stream from being generated by a vortex when the rotary chuck rotates. A guide member can be positioned between the bowl and the rotary chuck to guide the cleaning solution downwardly to a bottom portion of the bowl. A protector can extend from an inner side surface of the guide member toward the rotary chuck, to prevent an ascending air stream caused by the vortex.

### CROSS-REFERENCE TO RELATED APPLICATIONS

This application claims priority under 35 USC § 119 to Korean Patent Application No. 10-2005-0083285 filed on Sep. 7, 2005 in the Korean Intellectual Property Office, the contents of which are herein incorporated by reference in their entireties.

### BACKGROUND OF THE INVENTION

1. Field of the Invention

The present invention relates to apparatuses and methods for cleaning wafers. More particularly, the present invention relates to apparatuses and methods for cleaning semiconductor wafers by spraying a cleaning solution onto the wafer when the wafers rotate.

2. Description of the Related Art

Generally, a semiconductor device is manufactured through fabrication processes for forming electric circuits on a semiconductor substrate, such as a silicon wafer, an electrical die sorting (EDS) process for inspecting electrical characteristics of the electric circuits formed on the substrate, and a packaging process for sealing the semiconductor device using epoxy resin.

The fabrication processes usually include a deposition process for forming a layer on the substrate, a chemical mechanical polishing (CMP) process for planarizing the layer, a photolithography process for forming a photoresist pattern on the layer, an etching process for forming an electrical pattern from the layer using the photoresist pattern, an ion implantation process for implanting ions onto a predetermined region of the substrate, a cleaning process for removing particles from the substrate, and an inspection process for determining various defects within the wafer, including defects within the layer or the pattern.

The cleaning process is carried out in order to remove particles from the substrate before or after another process is performed. The cleaning process is classified into a single-type cleaning process and a batch-type cleaning process. In the single-type cleaning process, only one wafer is secured to a rotary chuck and the rotary chuck is rotated while the cleaning solution is injected onto the wafer. That is, the wafer is individually cleaned by a cleaning solution that is injected onto the wafer during the rotation thereof. In the batch-type cleaning process, a plurality of wafers is dipped into a container including a cleaning solution, so that the plurality of wafers is cleaned all together by the cleaning solution.

FIG. 1 is a cross-sectional view illustrating a structure of a conventional apparatus for cleaning a wafer through a single-type cleaning process.

Referring to FIG. 1, the conventional apparatus 1 for cleaning a wafer (hereinafter referred to as a “wafer cleaning apparatus”) includes a rotary chuck 10, a cleaning solution supply unit 20, a bowl 30 and a guide member 40. A wafer 50 is secured to the rotary chuck 10 and the rotary chuck 10 is rotated with respect to a central axis thereof, so that the wafer is supported and rotated on the rotary chuck 10. The cleaning solution supply unit 20 provides a cleaning solution onto the wafer 50. The bowl 30 is spaced apart from the rotary chuck 10 and surrounds the rotary chuck 10. The guide member 40 prevents the cleaning solution from being dropped again onto the wafer after being dispersed from the wafer and guides the dispersant cleaning solution to flow downwardly to a bottom of the bowl.

A circumferential surface of the rotary chuck 10 is formed into a stepped shape, to include a protrusion part 12 formed as the stepped portion of the circumferential surface thereof. When the rotary chuck rotates at a high speed, a vortex occurs between the rotary chuck 10 and the bowl 30, which can be largely due to the protrusion part 12. The vortex can generate an ascending air stream between the rotary chuck 10 and the bowl 30 and the ascending air stream can cause the cleaning solution, which flows downwardly to the bottom of the bowl 30 between the rotary chuck 10 and the bowl 30, to flow upwardly between the rotary chuck 10 and the bowl 30 so that the cleaning solution flows in a reverse direction, upwardly back onto the wafer. The reverse flowed cleaning solution can generate various processing defects on a surface of the wafer 50.

An exhaust pressure applied to an outlet 31 through which the dispersant cleaning solution is exhausted can locally attenuate the vortex at a lower portion of the bowl 30. However, since the exhaust pressure is locally applied around the outlet 31 at the bottom of the bowl 30, the vortex between the rotary chuck 10 and the bowl 30 is difficult to attenuate in this manner.

### SUMMARY OF THE INVENTION

Provided are apparatuses for cleaning wafers capable of minimizing an effect of a vortex around a rotary chuck therein.

According to one aspect of the present invention, there is a provided an apparatus for cleaning a wafer, comprising: a rotary chuck for supporting and rotating the wafer; a cleaning solution supply unit for supplying a cleaning solution onto the wafer; a bowl surrounding the rotary chuck, wherein a space is maintained between the bowl and the rotary chuck; and a protrusion portion having a slope face extending from a side surface of the rotary chuck, the protrusion portion configured to prevent an ascending air stream generated by a vortex between the rotary chuck and the bowl when the rotary chuck rotates.

The slope face of the protrusion portion can comprise a first face sloped downwardly and away from the rotary chuck and toward the bowl and a second face sloped upwardly and away from the rotary chuck and toward the bowl.

The first and second faces can meet to form an edge that is rounded.

A length of the first face can be substantially identical to or smaller than a length of the second face.

The rotary chuck can include an upper portion configured to support the wafer and a lower portion configured to support the upper portion, wherein a diameter of the upper portion of the rotary chuck can be substantially identical to or larger than a diameter of the lower portion of the rotary chuck.

A guide member can be disposed between the bowl and the rotary chuck, the guide member can be configured to guide the cleaning solution downwardly to a bottom portion of the bowl to substantially prevent the cleaning solution from being rebounded onto the wafer from an inner wall of the bowl.

The guide member can comprise a tapered hollow cylinder including an open top portion and an open bottom portion, the opening of the top portion of the guide member can be smaller than the opening of the bottom portion of the guide member.

A protector can extend from an inner side surface of the guide member toward the rotary chuck, the protector can be configured to substantially prevent an ascending air stream caused by the vortex.

The protector can be inclined to extend upwardly from the inner side surface of the guide member and toward the rotary chuck.

The protector can comprise a plurality of holes formed therein, wherein the plurality of holes can be configured to define a path through which the cleaning solution dispersed from the wafer into a region between the guide member and the protector is discharged toward the bottom portion of the bowl.

The protector can be integrally formed with the guide member.

The protector can be disposed at a height substantially the same as or lower than a top surface of the rotary chuck.

A plurality of outlets can be formed at a bottom portion of the bowl, the outlets can be spaced apart from a center of the bowl by a substantially similar distance and spaced apart from one another by a substantially similar distance, so that the outlets are substantially uniformly spaced apart along a circumferential line of a circle having a center that is substantially coincident with the center of the bowl.

The rotary chuck can comprise a plurality of supports for supporting an edge portion of the wafer; a band shaped into a circular stripe and configured to support the supports; and a base connected to the band and shaped into a circular disk, the base including a hole at a center portion thereof.

The cleaning solution supply unit can comprise a first cleaning solution supply unit configured to provide a cleaning solution onto a front surface of the wafer; and a second cleaning solution supply unit configured to provide a cleaning solution onto a rear surface of the wafer.

The rotary chuck can further comprise a plurality of openings interposed between the band and the base, the plurality of openings can be configured to discharge cleaning solution supplied through the second cleaning solution supply unit onto the rear surface of the wafer.

Each of the supports can comprise an O-ring positioned toward a center of the rotary chuck.

### BRIEF DESCRIPTION OF THE DRAWINGS

Various aspects of the invention will become more apparent in view of the attached drawing figures, which are provided by way of example, not by way of limitation, in which:

FIG. 1 is a schematic cross-sectional view illustrating a conventional single-type apparatus for cleaning a wafer;

FIG. 2 is a cross-sectional view illustrating an example embodiment of an apparatus for cleaning a wafer in accordance with aspects of the present invention;

FIG. 3 is a cross-sectional view illustrating an example embodiment of an apparatus for cleaning a wafer in accordance with aspects of the present invention;

FIG. 4 is a cross-sectional view illustrating an example embodiment of an apparatus for cleaning a wafer in accordance with aspects of the present invention;

FIG. 5 is a graph showing experimental results on the vortex caused by a rotation of a rotary chuck in a conventional wafer cleaning apparatus; and

FIG. 6 is a graph showing experimental results on the vortex caused by a rotation of a rotary chuck in the wafer cleaning apparatus shown in FIG. 2.

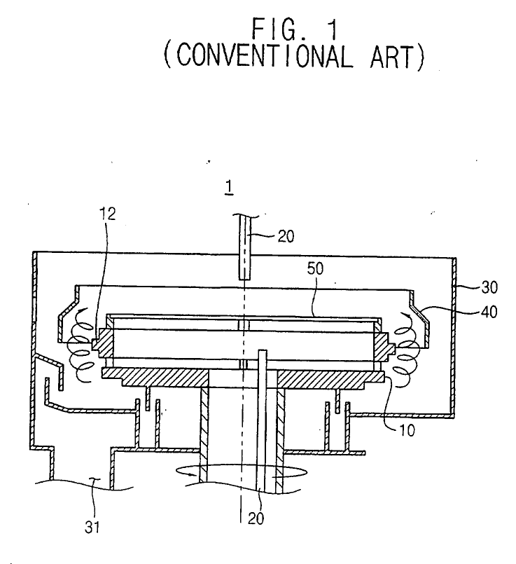

### DESCRIPTION OF THE EMBODIMENTS

The accompanying drawings are described below, in which example embodiments in accordance with the present invention are shown. The present invention can, however, be embodied in many different forms and should not be construed as limited to the example embodiments set forth herein. In the drawings, the sizes and relative sizes of layers and regions can be exaggerated for clarity.

It will be understood that when an element or layer is referred to as being “on,” “connected to” or “coupled to” another element or layer, it can be directly on, connected to or coupled to the other element or layer or intervening elements or layers can be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will also be understood that, although the terms first, second, third etc. can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper,” “front,” “rear,” “top,” “bottom,” and the like, can be used herein for ease of description to describe one element's or feature's relationship to another one or more element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device can be otherwise oriented (e.g., rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprise,” “comprises,” “comprising,” “include,” includes,” and/or “including,” when used in this specification and/or the claims, specify the presence of stated features, integers, steps, operations, elements, and/or components, but do not preclude the presence or addition of one or more other features, integers, steps, operations, elements, components, and/or groups thereof.

With respect to the example embodiments described herein, variations from the shapes of the illustrations as a result, for example, of manufacturing techniques and/or tolerances, are to be expected. Thus, the example embodiments should not be construed as limited to the particular shapes or relative sizes of regions illustrated herein, but are intended to include or allow for deviations in shapes or relative sizes that result, for example, from manufacturing processes or typically acceptable tolerance ranges. For example, an implanted region illustrated as a rectangle will, typically, have rounded or curved features and/or a gradient of implant concentration at its edges, rather than a binary (or absolute) change from implanted to non-implanted region. Likewise, a buried region formed by implantation can result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

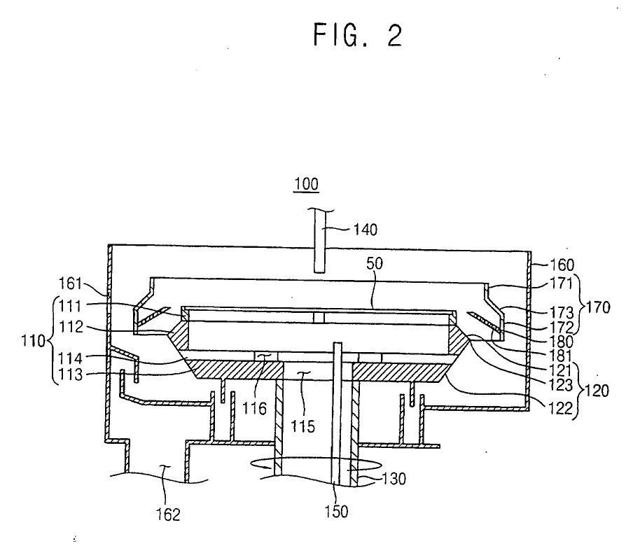

FIG. 2 is a cross-sectional view illustrating an embodiment of a structure of an apparatus for cleaning a wafer. The wafer cleaning apparatus 100 includes a rotary chuck 110, a protrusion portion 120, a rotary shaft 130, a first cleaning solution supply unit 140, a second cleaning solution supply unit 150, a bowl 160, a guide member 170 and a protector 180.

A wafer 50 is loaded or secured to the rotary chuck 110 and the rotary chuck 110 is rotated with respect to a central axis thereof (not shown), so that the wafer 50 is supported and rotated on the rotary chuck 110. The rotary chuck 110 includes a support 111, a band 112, a base 113 and one or more connectors 114. The support 111 can be a substantially solid ring or it can be comprised of a plurality of support members or elements arranged in a ring shape.

In the present embodiment, the support 111 is positioned on the band 112, and the wafer 50 makes direct contact with the support 111, so that the wafer 50 is supported by the support 111. The support 111 includes a horizontal portion and a vertical portion, a cross section of which forms an “L” shape in this embodiment. The horizontal portion of the support 111 supports a peripheral portion of a rear or bottom surface of the wafer 50, and the vertical portion of the support 111 supports a side surface or edge of the wafer 50. That is, the horizontal portion of the support 111 applies to the wafer 50 a first set of reaction forces parallel to a direction of the central axis of the chuck 110, i.e., orthogonal to a top surface of the wafer 50, which correspond to gravitational forces, i.e., weight of the wafer. Additionally, the vertical portion of the support 111 applies to the wafer 50 a second set of reaction forces in a radial direction toward the central axis of the chuck 110, which correspond to centripetal forces of the rotating wafer.

The support 111 can further include an O-ring at the horizontal portion thereof. A center of the O-ring is coincident with a center of the rotary chuck 100, which intersects with the central axis of the chuck 110. Thus, although the cleaning solution can permeate into the O-ring, the cleaning solution can be exhausted from the O-ring by a rotation of the rotary chuck 110.

While the present example embodiment discloses that the support 110 is formed in the capital letter ‘L’ shape, any other shape known to one of the ordinary skill in the art can also be utilized in place of the capital letter ‘L’ shape. In such alternative embodiments, an external force is exerted to the wafer when the wafer is rotated and substantially no external force is exerted to the wafer when the wafer is stationary.

In the present embodiment, the band 112 is formed in a circular shape, and makes contact with and supports the support 111. Accordingly, the band 112 prevents a deflection of the support 111.

In the present embodiment, the base 113 has a disk shape and includes a first hole 115 at a central portion thereof. The base 113 supports the band 112 and is connected to the rotary shaft 130. The first hole 115 can provide a space through which various elements or instruments have access to the rear or bottom surface of the wafer 50 when secured to the rotary chuck 110.

Hereinafter, an outer diameter of an upper surface of the band 112 is referred to as a first diameter, and an outer diameter of the base 113 is referred to as a second diameter. In an example embodiment, the second diameter can be substantially identical to or smaller than the first diameter, so that the vortex can be sufficiently prevented in a region between the chuck 110 and the bowl 160 when the chuck 110 is rotated.

The one or more connectors 114 is a plurality of the connectors 114 positioned along a peripheral portion of the base 113. Each of the connectors 114 is spaced apart from one another at substantially the same interval, in the present embodiment. The band 112 and the base 113 are connected to each other via the connectors 114. A plurality of second gaps or holes 116 is formed between the connectors 114. The cleaning solution is exhausted through the second holes 116.

The rotary shaft 130 delivers a driving force generated by a driving unit (not shown) to the rotary chuck 110. The rotary shaft 130 is connected to the base 113 of the rotary chuck 110. In the present embodiment, the rotary shaft 130 is a hollow shaft.

The bowl 160 surrounds the rotary chuck 110 and a gap or space is maintained between the bowl 160 and rotary chuck 110. A top portion of the bowl 160 is open and a slit 161 is formed at a side surface of the bowl 160. The wafer 50 moves through the slit 161, so the slit 161 has a width larger than a diameter of the wafer 50. Further, the slit 161 is positioned at a sufficient height to facilitate a motion of a transfer arm (not shown). In particular, a top of the slit 161 is higher than the support 111 at least by a thickness of the wafer 50, and a bottom of the slit 161 is lower than the support 111 at least by a thickness of the transfer arm.

In an example embodiment of the present invention, the transfer arm includes a paddle, so that the wafer 50 can be inserted through the slit 161 without making contact with the support 111 when the wafer 50 is loaded on or unloaded from the rotary chuck 110.

The bowl 160 can include an outlet 162 at a bottom portion thereof. The outlet 162 is configured to drain out the cleaning solution from the bowl 160 after cleaning the wafer 50. The cleaning solution can be discharged from the bowl 160 by a weight thereof or a pump (not shown) coupled to the outlet 162.

The first cleaning solution supply unit 140 provides a cleaning solution onto a front or top surface of the wafer 50 in order to remove impurities or particles from the wafer 50. In one example embodiment, as shown in FIG. 2, the first cleaning solution supply unit 140 can be positioned at a top portion of the bowl 160 perpendicular to the wafer 50. In another example embodiment, the first cleaning solution supply unit 140 can be positioned on an outer sidewall of the bowl 160 and can extend toward a center of the bowl 160.

When the cleaning solution is provided onto the wafer 50 through the first cleaning solution supply unit 140, the cleaning solution spreads out on the front or top surface of the wafer 50 from a central portion to a peripheral portion of the wafer 50 by a centrifugal force applied to the wafer 50 to thereby clean the wafer 50.

The second cleaning solution supply unit 150 provides a cleaning solution onto the rear or bottom surface of the wafer 50 in order to remove impurities or particles from the wafer 50. The second cleaning solution supply unit 150 is arranged to penetrate through the hollow rotary shaft 130 and the first hole 115 of the base 113.

The cleaning solution provided through the second cleaning solution supply unit 150 can not clean the whole rear or bottom surface of the wafer 50 with the centrifugal force applied to the wafer 50 in the same way as performed on the front surface of the wafer 50. The cleaning solution is directed, e.g., perpendicularly, onto the rear surface of the wafer 50 from a position beneath the wafer 50. As a result, the cleaning solution does not spread out on the rear surface of the wafer 50 due to gravity. Hence, a plurality of the second cleaning solution supply units 150 can be arranged to simultaneously direct the cleaning solution onto many points of the rear or bottom surface of the wafer 50. In the present embodiment, the cleaning solution is provided onto a central portion, a peripheral portion and a medium portion between the central and peripheral portions of the wafer 50 at the same time, so that substantially the entire rear or bottom surface of the wafer 50 can also be cleaned, even though the cleaning solution does not spread out to the rear surface of the wafer 50, as it does on the front or top surface of the wafer.

The cleaning solution is simultaneously provided onto the front and rear surfaces of the wafer 50, respectively, through the first and second cleaning solution supply units 140 and 150, so that both of the front and rear surfaces of the wafer 50 may be simultaneously cleaned. Alternatively, the cleaning solution can be provided only onto the front surface of the wafer 50 through the first cleaning solution supply unit 140, so that only the front surface of the wafer 50 can be cleaned.

The protrusion portion 120 is protruded from a side surface of the rotary chuck 110 and includes a first slope angled downwardly with respect to a top surface of the band 112 and a second slope angled upwardly with respect to a bottom surface of the base 113. As a result, a first face 121 of the protrusion portion 120 having the first slope is formed and connected to the top surface of the band 112. Additionally, a second face 122 of the protrusion portion 120 having the second slope is formed and connected to the bottom surface of the base 113. In FIG. 2, the first and second faces 121 and 122 terminate at a common point 123 of the protrusion portion 120.

The first and second faces 121 and 122 can be curved or planar, as examples. The first face 121 has a first slope length that is measured from an edge of the top surface of the band 112 to the point 123, and the second face 122 has a second slope length that is measured from an edge of the bottom surface of the base 113 to the point 123. In an example embodiment, the first slope length is substantially identical to or smaller than the second slope length, so that an ascending air stream generated due to a vortex between the rotary chuck 110 and the bowl 160 when the rotary chuck 110 is rotated may be sufficiently prevented.

While the example embodiment discloses that the second face 122 is connected to the bottom surface of the base 113, the second face 122 can also be connected to a bottom surface of the band 112, as would be appreciated by one of the ordinary skills in the art.

In the embodiment of FIG. 2, the second face 122 of the protrusion portion 120 has no stepped portion, so that a lower side surface of the rotary chuck 110 is much simpler than that of a conventional rotary chuck, thereby substantially preventing generation of the vortex between the rotary chuck 110 and the bowl 160 when the rotary chuck 110 is rotated. As a result, ascending air stream due to any such vortex may be minimized and the used cleaning solution may be sufficiently prevented from being reversely flowed onto the wafer 50. Accordingly, wafer contamination caused by a reverse flow of the used cleaning solution may be minimized.

The guide member 170 is positioned between the rotary chuck 110 and the bowl 160, and is secured to the rotary chuck 110. The guide member 170 prevents the cleaning solution from bouncing and dispersing from the wafer 50, so that the cleaning solution may be prevented from rebounding on an inner surface of the bowl 160 toward the wafer 50. Further, the guide member 170 guides the cleaning solution to flow down to the bottom portion of the bowl 160.

In an example embodiment, the guide member 170 includes an upper portion 171, a lower portion 172 and a tapered portion 173. The upper and lower portions 171 and 172 of the guide member 170 are shaped into a hollow cylinder of which top and bottom portions formed therein are open, respectively. The upper portion 171 has a third diameter and the lower portion 172 has a fourth diameter greater than the third diameter. The upper and lower portions 171 and 172 are connected to each other via the tapered portion 173. The guide member 170 is positioned such that the tapered portion 173 may be located at a height substantially the same as that of the wafer 50 supported by the rotary chuck 110.

The tapered portion 173 can have an angle of about 10 to about 60 degrees with respect to a horizontal surface, for example, a front or top surface of the wafer 50 or the top surface of the band 112. But in other embodiments, other angles could be used.

The guide member 170 can be movable in upward and downward directions by a driving unit (not shown). In the present embodiment, to accommodate loading and unloading of the wafer 50 into and out of the rotary chuck 110, the guide member 170 is movable to a first position that is higher than the slit 161. But when the wafer 50 is loaded into the rotary chuck 110 (e.g., for cleaning), the guide member 170 is movable to a second position that extends lower than the slit 161.

When the guide member 170 is positioned at the first position, the transfer arm holding the wafer 50 moves into the bowl 160 through the slit 161 until the wafer 50 is loaded on the rotary chuck 110. As described above, the slit 161 is formed on the side surface of the bowl 160 at such a sufficient height that the transfer arm may have access to the horizontal portion of the support 111. Then, the transfer arm moves out from the bowl 160 without any contact with the wafer 50 that is stationary on the rotary chuck 110. Therefore, the guide member 170 at the first position facilitates the loading/unloading of the wafer 50 to and from the rotary chuck 110.

When a cleaning process is performed on the wafer 50 loaded in the rotary chuck 110, the guide member 170 moves to a second position having substantially the same height as the slit 161. When the guide member 170 is located at the second position, the tapered portion 173 of the guide member 170 is positioned at about the same height as the wafer 50 secured to the rotary chuck 110. Thus, when the cleaning solution is dispersed from the surface of the wafer 50 due to the rotation of the chuck 110, the guide member 170 guides the dispersed clean solution to flow downwardly to the bottom portion of the bowl 160, thereby preventing the dispersed cleaning solution from bouncing toward the wafer 50. Particularly, the dispersed cleaning solution collides against the tapered portion 173 of the guide member 170, and is rebounded downwardly toward the bottom portion of the bowl 160. That is, the dispersed cleaning solution is rebounded from the tapered portion 173 in a direction that downwardly goes away from the wafer 50 loaded in the rotary chuck 110.

The protector 180 extends upwardly from the lower portion 172 of the guide member 170 toward the rotary chuck 110. The protector 180 includes one end that is connected to the lower portion of the guide member 170, which can be slightly lower than the wafer 50. The protector 180 includes another end that can be positioned proximate to the outer edge of the support 111 and the wafer 50.

In an example embodiment, the protector 180 is inclined at a slope angle such that the end connected to the guide member 170 may be lower than the end that is proximate to the wafer 50. The slope angle can, for example, range from about 10° to about 60° with respect to a horizontal surface substantially perpendicular to the lower portion 172 of the guide member 170. As a result, the protector 180 is shaped into a truncated cone shape in which a lower diameter is greater than an upper diameter. In other embodiments, other slope angles could be used. The protector 180 can be formed intergral with or detachably connected to the guide member 170.

A plurality of third holes 181 can be formed in the protector 180. The cleaning solution dispersed from the rotating wafer 50 during the cleaning process can gather in a space formed between a top surface of the protector 180 and the guide member 170. The dispersed cleaning solution in that space flows down to the bottom portion of the bowl 160 through the third holes 181. For the above reason, the third holes 181 are preferably arranged at a boundary portion adjacent or proximate to the guide member 170, rather than at the distal portion of the protector 180.

While the above example embodiment discloses that the protector 180 extends in a direction upwardly from the lower portion 172 of the guide member 170, the protector 180 can alternatively extend in a downward direction or can extend in a horizontal direction from the lower portion 172 of the guide member 170, as would be known to a person having ordinary skill in the art. When the protector 180 extends in a downward direction from the lower portion 172 of the guide member 170, the protector can also be shaped into a reversely truncated cone shape in which a lower diameter is smaller than an upper diameter. When the protector extends in a horizontal direction, the protector can be shaped into a ring.

The protector 180 can prevent the generation of an ascending air stream caused by the vortex. As a result, used cleaning solution is sufficiently prevented from being reversely flowed onto the wafer. Additionally, wafer contamination due to a reverse flow of the used cleaning solution is minimized.

Although not shown, the wafer cleaning apparatus 100 can further include supply lines through which a fluid or a gas for drying the cleaned wafer is supplied into the bowl.

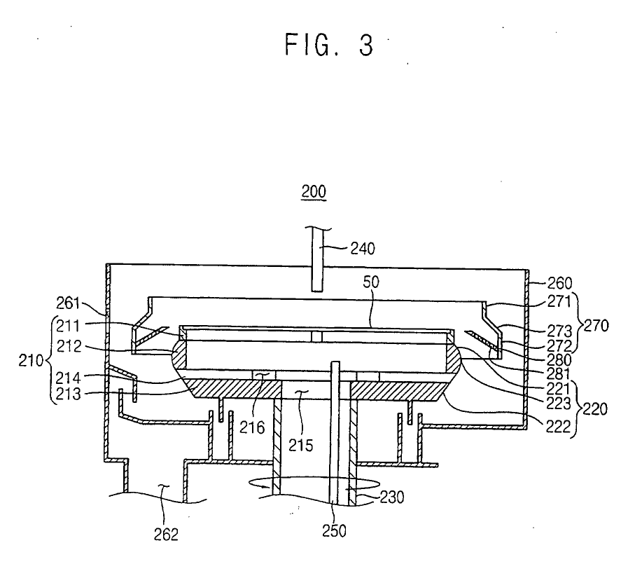

FIG. 3 is a cross-sectional view illustrating an apparatus for cleaning a wafer in accordance with another example embodiment. Referring to FIG. 3, a wafer cleaning apparatus 200 includes a rotary chuck 210, a protrusion portion 220, a rotary shaft 230, a first cleaning solution supply unit 240, a second cleaning solution supplying unit 250, a bowl 260, a guide member 270 and a protector 280.

The wafer cleaning apparatus 200 shown in FIG. 3 has the same elements as in the wafer cleaning apparatus 100 described with reference to FIG. 2, except the protrusion portion 220 is shaped differently. In FIG. 3, the reference numerals similar to those used in FIG. 2 denote the same elements. For instance, elements 110-116 correspond to elements 210-216; elements 130, 140, 150 and 160-162 correspond to elements 230, 240, 250 and 260-262; elements 170-173 correspond to elements 270-273; and elements 180-181 correspond to elements 280-282. Thus detailed descriptions of the same elements will be omitted. But elements 120-123 do not correspond to elements 220-223, so these are described below.

The protrusion portion 220 is protruded from a side surface of the rotary chuck 210 and includes a first slope with respect to a top surface of the band 212 and a second slope with respect to a bottom surface of the base 213. As a result, a first face 221 of the protrusion portion 220 having the first slope is connected to the top surface of the band 212 and a second face 222 of the protrusion portion 220 having the second slope is connected to the bottom surface of the base 213. In the present embodiment, the first and second faces 221 and 222 are shaped into a concave surface, so that the protrusion portion 220 includes a rounded point 223 at which the first and second faces 221 and 222 meet. Accordingly, the protrusion portion 220 has a curved shape.

The first face 221 has a first slope length that is measured from an edge of the top surface of the band 212 to the rounded point 223, and the second face 222 has a second slope length that is measured from an edge of the bottom surface of the base 213 to the rounded point 223. In an example embodiment, the first slope length is substantially identical to or smaller than the second slope length, so that an ascending air stream due to a vortex is sufficiently prevented between the rotary chuck 210 and the bowl 260 when the rotary chuck 210 is rotated.

While the present example embodiment discloses that the second face 222 is connected to the bottom surface of the base 213, the second face 222 can alternatively be connected to a bottom surface of the band 212.

The second face 222 of the protrusion portion 220 has no stepped portion. Accordingly, a lower side surface of the rotary chuck 210 is much simpler than that of a conventional rotary chuck. In the present embodiment, the vortex between the rotary chuck 210 and the bowl 260 is sufficiently prevented when the rotary chuck 210 is rotated. As a result, an ascending air stream due to the vortex may be minimized and the used cleaning solution is sufficiently prevented from being reversely flowed onto the wafer 50. Additionally, wafer contamination due to a reverse flow of the used cleaning solution may be minimized.

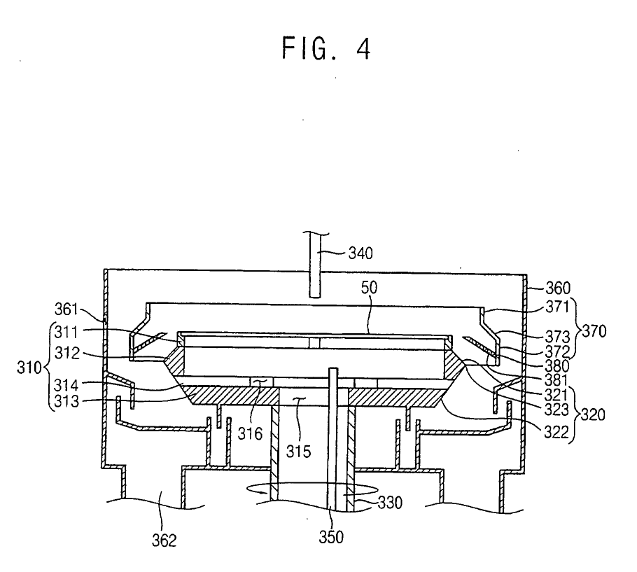

FIG. 4 is a cross-sectional view illustrating an apparatus for cleaning a wafer in accordance with another example embodiment. Referring to FIG. 4, a wafer cleaning apparatus 300 includes a rotary chuck 310, a protrusion portion 320, a rotary shaft 330, a first cleaning solution supply unit 340, a second cleaning solution supply unit 350, a bowl 360, a guide member 370 and a protector 380. These elements are the same as the elements 110, 120, 130, 140, 150, 160, 170 and 180 of FIG. 2.

The wafer cleaning apparatus 300 shown in FIG. 4, therefore, has substantially the same elements as in the wafer cleaning apparatus 100 described with reference to FIG. 2, except the amount and positions of the outlets 362 are not the same as the corresponding elements 162 in FIG. 2. A description of the elements that are common between FIG. 2 and FIG. 4 is omitted.

A plurality of the outlets 362 are formed at a bottom portion of the bowl 360. The outlets 362 drain out the cleaning solution from the bowl 360 after cleaning a wafer 50. In the present embodiment, the outlets 362 are located at uniform intervals away from a center of the bowl 360. That is, the outlets 362 are uniformly spaced apart along a circumferential line of a circle having a center that is coincident with the center of the bowl 360.

The cleaning solution can be discharged from the bowl 360 by a weight thereof or a pump (not shown) coupled to the outlet 362. When the cleaning solution is discharged from the bowl 360 by the pump, a pump pressure can sufficiently prevent an ascending air stream from being generated by a vortex between the rotary chuck 310 and the bowl 360. The outlets 362 are uniformly arranged at the bottom portion of the bowl 360, and consequently, the ascending air stream can be substantially uniformly prevented in the bowl 360.

Experiments on the Vortex in the Bowl

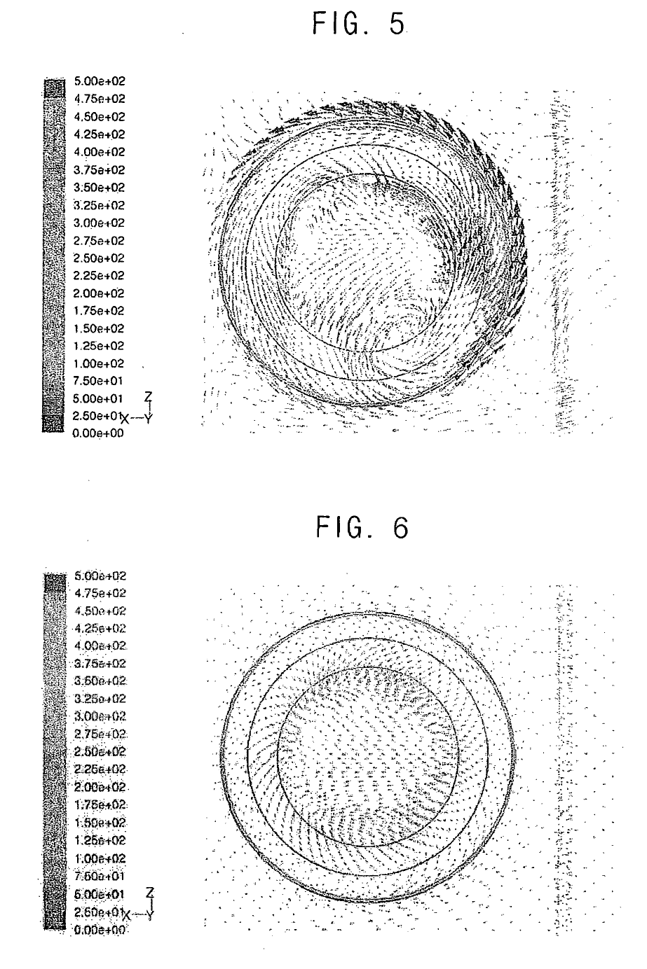

FIG. 5 is a graph showing experimental results of a vortex caused by a rotation of a rotary chuck in a conventional wafer cleaning apparatus. A large vortex occurred around the side surface and a portion of the top surface of the rotary chuck when the rotary chuck was rotated. The vortex around the side surface of the rotary chuck was attenuated near the outlet due to an outlet pressure in that area.

FIG. 6 is a graph showing experimental results of a vortex caused by a rotation of a rotary chuck in the wafer cleaning apparatus shown in FIG. 2. The vortex hardly occurred around the rotary chuck even when the rotary chuck was rotated because the protrusion portion of the guide member protruded from a side surface of the rotary chuck and the protector extended from the lower portion of the guide member toward the rotary chuck to sufficiently prevent the formation of a vortex between the rotary chuck and the bowl. Accordingly, since the vortex between the rotary chuck and the bowl was sufficiently prevented when the rotary chuck was rotated, an ascending air stream due to the vortex was minimized. As a result, the used cleaning solution was substantially prevented from being reversely flowed onto the wafer 50. Wafer contamination due to a reverse flow of the used cleaning solution was minimized.

According to the present disclosure, a wafer cleaning apparatus includes a protrusion portion protruded from a side surface of a rotary chuck and has a slope face with respect to the side surface of the rotary chuck and a protector extending from a guide member and preventing the cleaning solution from dispersing. The protrusion portion of the guide member and the protector sufficiently prevent the vortex between the rotary chuck and the bowl. Accordingly, the vortex between the rotary chuck and the bowl is sufficiently prevented when the rotary chuck is rotated, and an ascending air stream due to the vortex is minimized and the used cleaning solution is sufficiently prevented from being reversely flowed onto the wafer, thereby minimizing wafer contamination due to a reverse flow of the used cleaning solution.

The foregoing illustrative embodiments are not to be construed as limiting of the present invention. Although a few example embodiments in accordance with the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses, if any, are intended to cover the structures described herein as performing the recited functions and structural and functional equivalents. Therefore, it is to be understood that the present invention is not to be construed as limited to the specific example embodiments of the present invention disclosed herein, and that modifications to the disclosed example embodiments, as well as other embodiments, are intended to be included within the scope of the appended claims. The present invention is defined by the following claims, with equivalents of the claims to be included therein.

What is claimed is:

1. An apparatus for cleaning a wafer, comprising:
a rotary chuck for supporting and rotating the wafer;
a cleaning solution supply unit for supplying a cleaning solution onto the wafer;
a bowl surrounding the rotary chuck, wherein a space is maintained between the bowl and the rotary chuck; and
a protrusion portion having a slope face extending from a side surface of the rotary chuck, the protrusion portion configured to prevent an ascending air stream generated by a vortex between the rotary chuck and the bowl when the rotary chuck rotates.

2. The apparatus of claim 1, wherein the slope face of the protrusion portion comprises a first face sloped downwardly and away from the rotary chuck and toward the bowl and a second face sloped upwardly and away from the rotary chuck and toward the bowl.

3. The apparatus of claim 2, wherein the first and second faces meet to form an edge that is rounded.

4. The apparatus of claim 2, wherein a length of the first face is substantially identical to or smaller than a length of the second face.

5. The apparatus of claim 1, wherein the rotary chuck includes an upper portion configured to support the wafer and a lower portion configured to support the upper portion, wherein a diameter of the upper portion of the rotary chuck is substantially identical to or larger than a diameter of the lower portion of the rotary chuck.

6. The apparatus of claim 1, further comprising a guide member disposed between the bowl and the rotary chuck, the guide member configured to guide the cleaning solution downwardly to a bottom portion of the bowl to substantially prevent the cleaning solution from being rebounded onto the wafer from an inner wall of the bowl.

7. The apparatus of claim 6, wherein the guide member comprises a tapered hollow cylinder including an open top portion and an open bottom portion, the opening of the top portion of the guide member being smaller than the opening of the bottom portion of the guide member.

8. The apparatus of claim 6, further comprising a protector extending from an inner side surface of the guide member toward the rotary chuck, the protector configured to substantially prevent an ascending air stream caused by the vortex.

9. The apparatus of claim 8, wherein the protector is inclined to extend upwardly from the inner side surface of the guide member and toward the rotary chuck.

10. The apparatus of claim 9, wherein the protector comprises a plurality of holes formed therein, wherein the plurality of holes are configured to define a path through which the cleaning solution dispersed from the wafer into a region between the guide member and the protector is discharged toward the bottom portion of the bowl.

11. The apparatus of claim 8, wherein the protector is integrally formed with the guide member.

12. The apparatus of claim 8, wherein the protector is disposed at a height substantially the same as or lower than a top surface of the rotary chuck.

13. The apparatus of claim 1, wherein a plurality of outlets are formed at the bottom portion of the bowl, the outlets being spaced apart from a center of the bowl by a substantially similar distance and spaced apart from one another by a substantially similar distance, so that the outlets are substantially uniformly spaced apart along a circumferential line of a circle having a center that is substantially coincident with the center of the bowl.

14. The apparatus of claim 1, wherein the rotary chuck comprises:
a plurality of supports for supporting an edge portion of the wafer;
a band shaped into a circular stripe and configured to support the supports; and
a base connected to the band and shaped into a circular disk, the base including a hole at a center portion thereof.

15. The apparatus of claim 14, wherein the cleaning solution supply unit comprises:
a first cleaning solution supply unit configured to provide a cleaning solution onto a front surface of the wafer; and
a second cleaning solution supply unit configured to provide a cleaning solution onto a rear surface of the wafer.

16. The apparatus of claim 15, wherein the rotary chuck further comprises a plurality of openings interposed between the band and the base, the plurality of openings configured to discharge cleaning solution supplied through the second cleaning solution supply unit onto the rear surface of the wafer.

17. The apparatus of claim 14, wherein each of the supports comprises an O-ring positioned toward a center of the rotary chuck.
